(19) United States
(12) Patent Application Publication
(10) Pub. No.: US 2006/0139338 A1
(43) Pub. Date: Jun. 29, 2006

(54) Transparent optical digitizer

(76) Inventors: Michael J. Robrecht, Shorewood, WI (US); Jessica L. Voss-Kehl, Inver Grove Heights, MN (US); Billy L. Weaver, Eagan, MN (US)

Correspondence Address: 3M INNOVATIVE PROPERTIES COMPANY, PO BOX 33427, ST. PAUL, MN, 55133-3427, US

(21) Appl. No.: 11/015,838

(22) Filed: Dec. 16, 2004

(51) Int. Cl. G09G 5/00

(52) U.S. Cl. 345/175

(57) ABSTRACT

The present invention provides a digitizer that includes a transparent overlay that incorporates a transparent material pattern that is coded to be indicative of position and detection device configured to read the pattern for determining position information. The transparent material of the coded pattern can include infrared sensitive materials, for example. Transparent digitizers of the present invention may be useful in applications such as Tablet PC mobile computers.

The present invention relates to digitizing user input devices.

### BACKGROUND

Touch sensors can provide a simple and intuitive way for a user to interface with a computer system, particularly for handheld and mobile computing applications. As mobile computing applications become more powerful, and users demand functionalities such as handwriting recognition, direct note taking on a computer platform, drawing, and so forth, additional requirements are placed on the input device in terms of accuracy and functionality.

### SUMMARY

The present invention provides a position detection device that includes a transparent overlay configured for viewing a display therethrough, the overlay including a pattern of transparent material, the pattern being indicative of position. The position detection device also includes a detection device configured to read the pattern when the detection device is suitably positioned. In some embodiments, the transparent material of the pattern can be an infrared sensitive material, and the transparent substrate can be infrared sensitive or infrared transparent. In some embodiments, the detection device can be a stylus that houses an imager configured to resolve the pattern.

The present invention also provides a method for making a position detection device, the method including providing a transparent substrate and patterning a transparent material in a coded pattern indicative of position on the substrate so that the coded pattern can be read by a detection device to determine position of the detection device when the detection device is suitably positioned adjacent to the substrate.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a digitizer system;

FIG. 2 schematically shows one embodiment of a digitizer overlay according to the present invention;

FIG. 3 schematically shows a detection stylus that may be useful in embodiments of the present invention;

FIGS. 4(a) and 4(b) show an example of an X-Y data array layout and a particular X-Y data array that may be implemented in coded patterns useful in the present invention;

FIG. 5 shows an example of nine neighboring X-Y data arrays according to the layout of FIG. 4; and

FIG. 6 schematically illustrates an experimental setup used to verify the detectability of coded patterns according to the present invention.

While the invention is amenable to various modifications and alternative forms, specifics thereof have been shown by way of example in the drawings and will be described in detail.

### DETAILED DESCRIPTION

The present invention relates to a digitizer system that includes an overlay that incorporates a detectable pattern indicative of location, the overlay suitable for disposing over a display so that the display is viewable therethrough. Elements through which a display can be viewed are referred to as transparent even though they may to some degree reduce the amount of visible light that reaches a viewing position, for example by introducing some coloration. Patterns embedded with retrievable information such as information that indicates position or location are referred to as coded patterns. Transparent digitizer overlays of the present invention incorporate a coded pattern that can be read by a detection device, for example one housed in a stylus, to determine position, orientation and/or movement information. Position detection can be performed even though the transparent digitizer overlay may include no electrical components and have no electrical connections to the system. Various benefits may be realized by using transparent digitizers of the present invention, including high light transmission and absolute location of a stylus position with high resolution and accuracy.

Digitizer systems of the present invention utilize a coded pattern of visibly transparent material that absorbs or reflects radiation that is outside of the visible spectrum, for example infrared radiation (IR) or ultraviolet (UV) radiation. Without loss of generality, aspects of the present invention may be described in this document with reference to IR sensitivity even though other wavelengths may be used. The coded pattern can be disposed on a transparent substrate that affects the non-visible radiation of interest differently than the material of the coded pattern, e.g., IR absorbing material patterned on an IR reflecting or transmissive substrate, or IR reflecting material patterned on an IR absorbing or transmissive substrate. A detection device, for example one fashioned as a stylus, that incorporates an optical imaging system sensitive to IR, for example, can be used to read the coded pattern to determine absolute position and movement of the stylus. In order to read the coded pattern, the pattern can be exposed to IR, which can originate from behind the digitizer (for example, from heat generated by a display or other light source) or from in front of the digitizer (for example, emitted from the detection device itself). Similar techniques can be used with other non-visible radiation. Alternatively, a transparent material can be patterned that emits radiation, including visible light, when exposed to certain wavelengths. For example, a fluorescent dye can be patterned on a transparent substrate to form the transparent digitizer overlay. A detection stylus could then be used to image the pattern by exposing a portion of the pattern to UV and detecting the light emitted by the fluorescent material excited by the UV exposure.

Digitizers of the present invention may be useful in systems that can benefit from an absolute coordinate input device. In exemplary embodiments, digitizers of the present invention can be incorporated into mobile computing devices such as tablet computers, known as Tablet PCs. Current commercially available Tablet PCs make use of copper grid circuit boards that are placed behind the display, such as those produced by Wacom Co., Ltd., Japan. It has also been suggested that Tablet PCs use transparent digitizers disposed in front of the display, for example transparent grid digitizers that utilize the sensing technology known as DMS available from IBM Corporation and disclosed in U.S. Pat. No. 4,686,332, the sensing technology developed by N-Trig. Ltd. and disclosed in International Publication WO 03/046882 A1, and the like. Such technologies utilize a grid of low visibility conductive material such as transparent conductive oxides like indium tin oxide (ITO) or conductive polymers like poly(3,4-ethylenedioxythiophene) (PEDOT). Very fine wire can also be used. Such technologies can interpolate the relative signal strengths of adjacent conductors in the grid to calculate the position of the stylus.

Technology also exists where a stylus with an imaging sensor can follow a visible coded grid printed on a piece of paper, as disclosed for example in U.S. Pat. Nos. 5,051,736; 5,852,434; 6,502,756; 6,548,768; 6,570,104; 6,586,688; 6,666,376; 6,674,427; 6,698,660; 6,722,574; and 6,732,927, each of which are incorporated wholly into this document.

The present invention provides a transparent digitizing sensor capable of providing absolute position information with sufficiently high resolution and high absolute accuracy for applications such as Tablet PCs, and in which the transparent overlay placed in front of the display need not have any electrical functionality or any electrical connections to function. In such systems, the stylus can contain an imaging system for resolving the coded pattern of the overlay as well as electronics for transmitting information such as position data, stylus up/down state, right click state, erase state or other information to the host system.

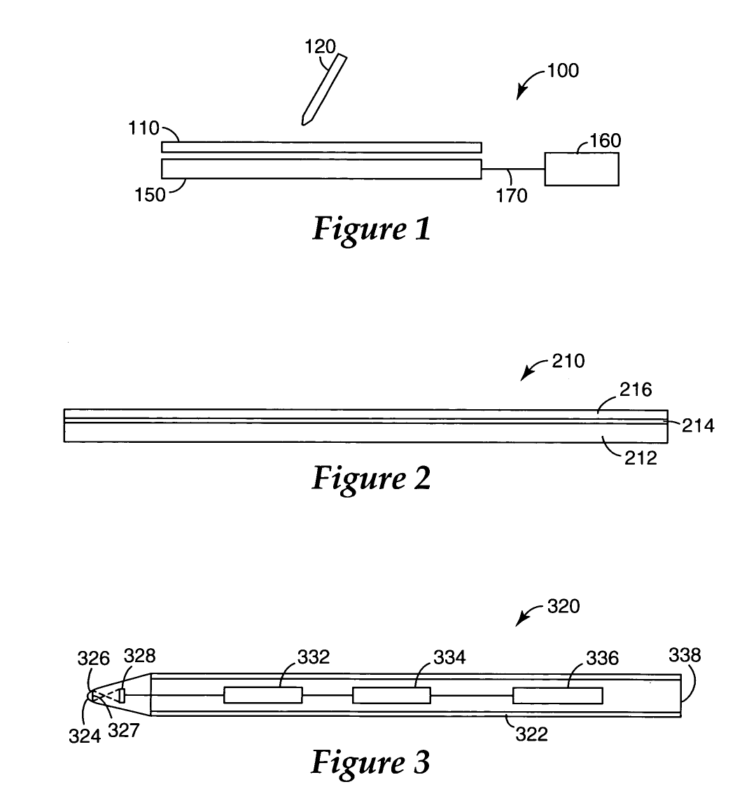

FIG. 1 shows a digitizer system 100 that includes a digitizer overlay 110 positioned over a display 150 that is viewable through the digitizer overlay 110. Digitizer overlay 110 includes a transparent pattern, for example one sensitive to IR, that is coded to reveal position information when imaged and resolved by the detection stylus 120, which can be configured to be sensitive to IR, for example. When detection stylus 120 is brought into sufficient proximity to the digitizer overlay 110, an imaging device in the stylus 120 can resolve the pattern of the overlay, optionally with the assistance of an optical system that includes one or more lenses or apertures, for example located at the tip of the stylus or within the stylus housing. The stylus can include electronics that interpret the detected image and determine stylus position, orientation, movement, or the like. This information can be transmitted to system electronics 160 through a wired connection or through wireless signal transmission. The stylus can also transmit image information or other raw or processed data to the system electronics 160 for further processing and determination of position or related information.

System electronics 160 may be connected to the display 150 through a signal transmission channel 170, which can be wired or wireless. Channel 170 allows communication between the display and the digitizer through the system electronics 160. This provides a feedback loop so that the results of the stylus input can be displayed, for example by moving a cursor, highlighting an icon, displaying images or other information, displaying a line drawn by the motion of the stylus, and so forth. Display 150 can be any electronic display such as a liquid crystal display (LCD), cathode ray tube, organic electroluminescent display, plasma display, and the like, as well as static images or graphics provided alone or in combination with an electronic display.

FIG. 2 shows an exemplary digitizer overlay 210 that may be used in the present invention. Overlay 210 includes a substrate 212, a patterned layer 214 that includes a transparent coded pattern indicative of position on the overlay, and an optional hardcoat layer 216 that may protect the coded pattern 214 when oriented as the input surface. Exemplary hardcoat materials include:acrylic and polycarbonate hardcoats as well as those that contain inorganic oxide particles (for example silica) dispersed in a binder, sometimes referred to as “ceramers.” Examples of a commercially available hardcoat is the one sold under the trade designation 3M 906 Abrasion Resistant Coating from 3M Company, St. Paul, Minn. Alternatively, substrate 212 can be oriented as the input surface. The overlay can be disposed over the display in a spaced relationship, or can be directly disposed on the display, for example through the use of an optical adhesive. In other embodiments, the coded pattern can be formed directly on the outer surface or element of the display. Other layers or elements such as adhesive layers, antiglare or matte coatings, antireflection coatings, and the like can also be incorporated into the overlay.

In some embodiments, digitizers of the present invention can be constructed using a substrate that is reflective in the IR spectrum and transmissive over the visible spectrum. An exemplary IR reflective and visible light transmissive film is one available from 3M Company under the trade designation SRF (Solar Reflecting Film). An IR absorbing material can then be printed or otherwise patterned onto a substrate that includes the IR reflecting film. For example an ink that is absorbing of IR wavelengths that are reflected by a film of SRF can be printed onto the SRF in a coded pattern that can be used to indicate position when the overlay is exposed to IR from in front of the overlay.

In other embodiments, transparent digitizers of the present invention can be constructed using a substrate that is absorptive in the IR spectrum and transmissive over the visible spectrum. An IR reflecting material can then be printed or otherwise patterned onto the IR absorbing substrate. In this configuration, IR illuminating the overlay from the front will be reflected by the pattern and absorbed by the exposed portions of substrate, thereby allowing an IR imager to resolve the pattern.

In still other embodiments, digitizers of the present invention can be constructed using a substrate that is transmissive in the IR spectrum and transmissive over the visible spectrum. An IR reflecting material or an IR absorbing material can then be printed or otherwise patterned onto the IR transmissive substrate. In this configuration, IR illuminating the overlay from the front can be reflected by the pattern and transmitted by the exposed portions of substrate, thereby allowing an IR imager to resolve the pattern. Also in this configuration, IR illuminating the overlay from the back can be transmitted by the substrate and then either reflected or absorbed by the pattern, thereby allowing an IR imager positioned in front of the overlay to resolve the pattern.

Exemplary materials for making an IR sensitive pattern include IR absorbing materials such as, for example, various particle dispersions such as those that incorporate indium tin oxide (ITO) and/or tin antimony oxide (TAO) nanoparticles in an acrylic matrix, the transparent IR absorbing perylene and naphthyl dyes available from BASF under the trade designations Lumogen IR 765 and 788, higher rylene dyes such as quaterrylenetetracaboxdiimide, and the materials identified in the publication Can. J. Chem., Volume 73, Pages 319-324 (1995), and having the following chemical structures: 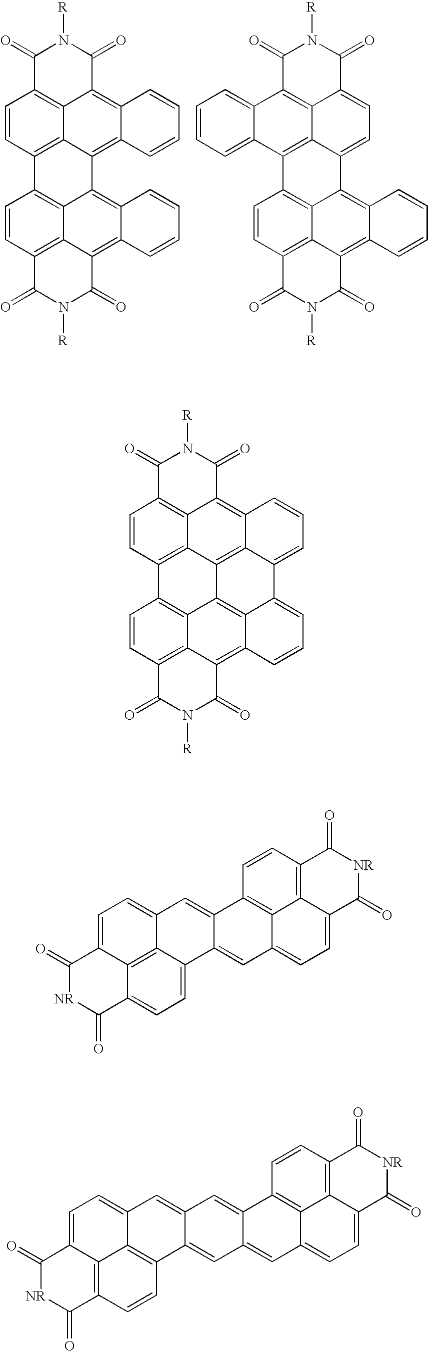
Exemplary materials for making an IR sensitive pattern also include IR reflecting materials such as, for example, the isoindoline colorants disclosed in U.S. Pat. Nos. 4,311,527 and 4,271,309, metals such as gold, silver, and materials such as titanium nitride, and the like, which can be made optically transparent when formed in very thin films, for example as disclosed in U.S. Pat. Nos. 5,071,206 and 5,306,547 for silver films and U.S. Pat. No. 6,541,182 and U.S. Pat. No. 6,188,152 for titanium nitride films. Such IR sensitive materials can be patterned by any suitable patterning technique, including various printing methods, lithography methods, transfer methods, removal methods such as ablation and etching, patterned deposition methods, and so forth.

Referring back to FIG. 2, transparent digitizer overlay 210 is shown including a single coded pattern 214 disposed in a single layer. Transparent digitizer overlays of the present invention can also include multiple different coded patterns disposed in one or more layers. Multiple patterns that are sensitive to different wavelengths can be used to provide different information (e.g., one for position and one for orientation), to provide an additional degree of accuracy (e.g., by interpolation using a combination of patterns), to identify particular regions dedicated to certain functions (e.g., when one of the multiple patterns is disposed only in certain regions), to aid in initial orientation and position calibration, and so forth. For example, a transparent substrate could include a first coded pattern on the top surface and a second coded pattern on the bottom surface, the substrate being of sufficient thickness relative to the spacings of the patterns that a stylus tilt angle and tilt direction can be determined based on the relative position of the lower pattern as compared to the upper pattern as seen by the stylus detector.

Systems of the present invention can include a stylus that contains a micro imaging camera and communication means such as a radio frequency (RF) link to send data to a host system. Alternatively, the stylus can be tethered to the host system. The image can be decoded in the stylus and coordinate data can be sent to the host, or raw image data can be sent from the stylus to the host and calculations performed at the host. The stylus can include an internal power source such as a battery, which may be rechargeable (for example, when docked with the host device), or could use an RF wireless power source. The stylus can also be configured to emit IR or other imaging radiation so that the digitizer overlay can be exposed and imaged by the stylus. Exemplary constructions of stylus detection devices for detecting visible coded patterns are disclosed in U.S. Pat. Nos. 5,051,736 and 5,852,434, each of which is wholly incorporated into this document. It is contemplated that similar constructions can be used for stylus detection devices sensitive to non-visible wavelengths for implementation in the present invention.

The stylus can also incorporate various switches for performing certain functions or determining certain stylus states, for example a stylus, tip switch that determines whether the stylus tip is in contact with a surface or a switch on the side of the stylus that can be activated by a user to signal a left or right mouse click function. An erase function could also be incorporated in the stylus, for example via a switch on the end of the stylus opposite the tip that can be actuated much like a click type ball point pen to put the stylus in erase mode and then back to writing mode. The hand movement for this function would be as easy as reversing a pencil to erase, or to reversing an electronic stylus such as that available in current digitizers.

FIG. 3 shows one embodiment of a detection stylus 320 that includes a housing 322 having a tip 324 and a back 338. The tip 324 includes an aperture 326 for receiving (and in some embodiments emitting) radiation for discerning the coded pattern. A lens 327 can be included to focus the radiation on an imaging device 328. Information from the imaging device can be decoded by a decoding circuit 332, and the signals generated can be transmitted to the system electronics by a data transmitting unit 334. A power source 336 can also be provided so that the stylus 320 can be a stand-alone, tetherless item. Power source 336 can be a fully self-contained power source such as a battery, or can be an RF pumped power circuit activated by an RF signal originating from a location remote from the stylus.

The detection stylus can additionally be used to detect and record stylus strokes whether the stylus is used in connection with the digitizer overlay or not. For example, the stylus can include a retractable inking tip that can be used to write on paper. If the paper is printed with a coded pattern that can be detected by the detection stylus, the stylus positions while writing can be recorded in a storage device located in the stylus. Optionally, the information can be communicated via wire or wireless connection to the host system or other device for processing, recording and/or storage. When the stylus is docked with or otherwise connected to a computer device (via wire or wireless connection), the stored stylus stroke information can be loaded onto the computer. Optionally, stylus strokes can be recorded and stored in a memory device contained within the stylus even when the stylus is used in connection with the digitizer overlay, for example for easy portability of the information to another computer device.

The coded pattern of transparent digitizer overlays of the present invention can be similar to a 2D bar code pattern on a sufficiently small scale so that the pattern when imaged and decoded reveals an absolute coordinate corresponding to the physical location, movement and/or orientation of the detection device, thereby determining information that can be used to control a cursor, perform a function, and so forth. Either directly or though interpolation techniques, position resolution of 500 points per inch (about 200 points per centimeter) or better can be achieved. Specifications for Tablet PC applications often require such high resolution. Exemplary patterns coded to indicate position include those disclosed in U.S. Pat. Nos. 5,051,736; 5,852,434; 6,502,756; 6,548,768; 6,570,104; 6,586,688; 6,663,008; 6,666,376; 6,667,695; 6,689,966; and 6,722,574, each of which is wholly incorporated into this document.

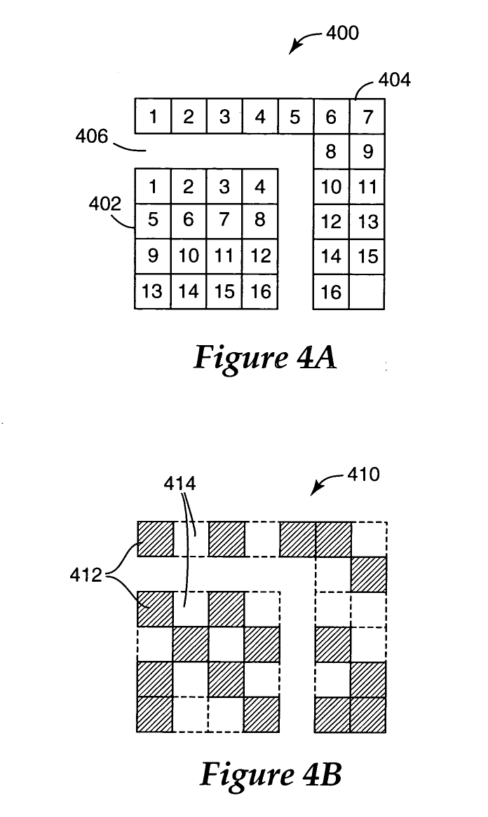

An example of how a coded pattern may be realized is depicted in FIGS. 4(a) and 4(b). In this example, 16 bit X and Y data are encoded in a two dimensional array of squares, depicted in FIG. 4(b) as cross-hatched squares 412 and open squares 414. In implementations of the present invention, the cross-hatched squares, the open squares, or both can be patterned from material that is sensitive to IR. FIG. 4(a) shows a data layout 400 depicting a format having a particular orientation that can be decoded with machine vision algorithms. The layout includes 16 bits of X data arranged in a 4 by 4 array 402 and 16 bits of Y data arranged in an “L” shaped array 404. The “L” shape of the Y data helps in identifying the orientation of the detection stylus, which can be rotated in a user's hand at any angle about its long axis. The “L” shaped zone 406 without data squares, along with the lower right corner (which could always be filled-in, for example) provide consistent features that can also allow orientation to be detected. FIG. 4(b) indicates an example of a single array 410 of X and Y data, which as shown has the binary X-Y coordinates of (1010010110101001, 1010110010010011) and the equivalent decimal X-Y coordinates of (42409, 44197). In this format, each data array could be a unique pair of 16 bit numbers ranging from 0 to 2¹⁶ that can be used to indicate coordinate position on the overlay.

In exemplary embodiments, the size of each X-Y data array can be such that the detection device in the stylus is capable of imaging more than one data array in each direction, for example up to three data arrays in each direction, when the stylus is positioned sufficiently proximate to the digitizer surface. Being able to image more than one X-Y data array can allow the use of interpolation techniques to further refine [symbol] positional accuracy as well as to verify positional determination accuracy in case one or more data bits is corrupted.

The pixels making up each data array can be patterned by photolithography, printing techniques such as ink jet printing, roto-gravure printing, offset printing, screen printing, thermal transfer printing, or the like, or by any other suitable technique. If the pixels of a data array were printed at 1000 dpi (dots per inch) (2540 dots/cm), the size of each data array would be about 0.006 inches square (0.015 cm×0.015 cm) (assuming some compression in the horizontal axis to account for the array being 7 pixels wide but only 6 pixels high). Such a size represents a dimension smaller than the pixel pitch of the typical LCD. If the pitch between individual data arrays were about 0.008 inches (0.02 cm), the detection device would image an area of about 0.025 inches by 0.025 inches (0.064 cm×0.064 cm) in order to see three data arrays in each direction simultaneously. Printing coded patterns of this size onto 60 inch (1.5 m) wide rolls of digitizer substrate film would yield 7500 data arrays across the substrate, which is something less than 2¹³. A repeat pattern in the down web direction of the substrate roll could be accomplished using a print cylinder having a diameter of a bit more than 19 inches (48 cm). For ink jet printing, the web direction image length could be controlled digitally. In the web direction, the data arrays could be printed in a continuous and repeating fashion. In such a configuration, any rectangle having a long dimension less than 60 inches (1.5 m) could be cut from anywhere in the web and have a unique data array pattern encoded on the surface without repeats.

For Tablet PC's, it is common to have a 12.1 inch (30.7 cm) diagonal display. When a sheet is cut from the web described above for a 12.1 inch (30.7 cm) display, a unique data array pattern, and therefore a unique set of X-Y positions, covers the entire area of the sheet. A one-time calibration can then be performed, for example at the factory when the Table PC is assembled. In the calibration, some number of points distributed around the digitizer, for example three or four points located in or near various corners, can be sensed by a detection stylus and mapped to the display. By detecting the corner data array, the scale, position, and orientation (for example, skew) of the digitizer can be determined from mathematical models and prior knowledge of the coded pattern.

Interpolation can be used to achieve higher resolution than that dictated by the spacing between X-Y data array positions. When a resolution of greater than five times the pixel pitch is desired, and the data arrays are spaced on a pitch less than that of the display pixels, only five steps of interpolation would be needed. A detector with resolution sufficient to resolve the image of about four times the size of each data pixel in a single data array would also be able to resolve the shift of one data pixel position, which results in an interpolation of approximately seven or eight between data arrays. An imaging chip having as few as 100 by 100 pixels of IR sensitive photo diodes or phototransistors would be sufficient. The optical lens system of the detection device can be configured to focus the area of 3 by 3 data arrays onto the imaging chip.

Preferably the optical system of the detection device can provide for enhanced performance by utilizing a sufficiently long depth of field to allow for position detection to take place at greater than five millimeters above the surface of the digitizer overlay. This allows hovering functionality whereby a cursor or other items displayed on the screen can be manipulated without the stylus contacting the screen. To achieve hover functionality, the imaging chip preferably has a resolution sufficient to resolve the data arrays at a lower magnification due to the distance from the surface. An infinite focus telescopic optical system can be devised that would aid in this functionality. The image could also be analyzed to determine height of the stylus above the surface based on the pitch of the data arrays detected in the field of the imager, which will increase as the stylus moves towards the surface. The lens and imaging chip portion of the stylus could be moveably mounted to the stylus barrel to allow for a switching mechanism that engages and disengages depending on whether the tip of the stylus is sufficiently contacting a surface. This can provide “pen up” and “pen down” information to the system. Combining hover with pen down detection can allow a user to sequence through a series of nested menus, for example, in hover mode, and then select the function associated with the desired menu item by touching down with the stylus. Hovering also improves touch down accuracy because it allows the user to see where the system is locating the stylus even before the stylus touches down.

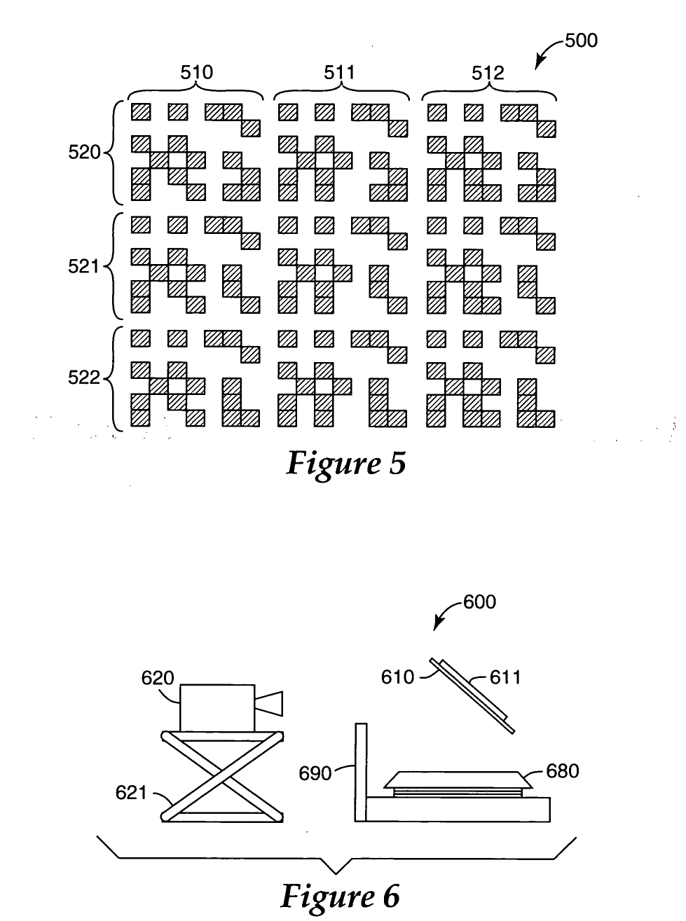

FIG. 5 shows a section of the data grid 500 with nine X-Y data arrays that might be “within the field of view of the imaging camera of a stylus detection device. Each of the data arrays in column 510 share the binary X coordinate of 1010010110101001, corresponding to the decimal X coordinate of 42409. Each of the data arrays in column 511 share the binary X coordinate of 1010010110101010, corresponding to the decimal X coordinate of 42410. Each of the data arrays in column 512 share the binary X coordinate of 1010010110101011, corresponding to the decimal X coordinate of 42411. Each of the data arrays in row 520 share the binary Y coordinate of 1010110010010011, corresponding to the decimal Y coordinate of 44179. Each of the data arrays in row 521 share the binary Y coordinate of 1010110010010100, corresponding to the decimal Y coordinate of 44180. Each of the data arrays in row 522 share the binary Y coordinate of 1010110010010101, corresponding to the decimal Y coordinate of 44181. If the nine data arrays shown in FIG. 5 represent what is within the field of view of the imager of the stylus detection device, the X and Y coordinates of the centermost data array may be identified as the stylus position. If higher accuracy is desired, the position of the central data array in the image relative to center can provide stylus position relative to an absolute position on the screen to a resolution greater than the pitch of the data array pixels. A validation can be performed in the case of a defect in the data printing by checking the neighboring data arrays and data array pixels to verify the sequential data integrity. If a data array pixel is bad, the correct position can be inferred from the adjoining arrays, and correct positional data can still be sent to the host.

During a drawing mode, the imaging software can switch from an absolute positioning mode to a relative positioning mode. If the absolute stylus position is known initially, the movement of the stylus can be calculated in relative terms by the movement of the image across the imaging device, much in the same manner as an optical mouse. Switching to a relative positioning mode may reduce the processing power required and improve the speed at which location position data can be sent to the host. This may be particularly important when writing, drawing, or performing other functions where the user may be more demanding of fast response times.

Advantages of systems of the present invention include the following. The digitizer overlay that covers the display screen can be constructed of a single sheet of polymer material that can be manufactured completely in wide web format and simply cut to size. Any area of the web can be cut out and will have unique absolute coordinates as long as the part is within the length of the repeat pattern of the coded data arrays. No electrical functionality is required in the digitizer overlay, and no connections need to be made to it. As such, the digitizer overlay can be very inexpensive to manufacture and to integrate into a system. The positional accuracy and resolution of systems of the present invention can be made extremely high to meet the demands of applications such as Tablet PCs. The electronic functionality can be entirely encompassed within the stylus, or can be split between the stylus and the host system.

The ability to resolve IR patterns made with IR sensitive inks on IR sensitive substrates was tested. An antimony-doped tin oxide nanoparticle dispersion in acrylates, trade designation SH7080, was obtained from Advanced Nanoproducts in Chungcheongbuk-do, Korea. Using a swab, the nanoparticle dispersion was applied in a thin grid pattern onto a corona treated multilayer optical film consisting of polyester and acrylic layers, available from 3M Company under the trade designation Solar Reflecting Film 1200 (SRF). The SRF is reflective of IR whereas the nanoparticle dispersion is absorptive of IR. The patterned film was then processed in a Fusion UV Processor from Fusion UV Systems Inc. of Gaithersburg, Md., using an H bulb and a belt speed of 25 feet per minute for a total UV-A dose of 1.16 J/cm². This cured the dispersion and adhered it to the IR reflecting film.

The thin, cured dispersion was observed to be transparent to visible light and had a slight blue tint. A piece of SRF with no coating was used as a control. The sample and the control were both visually transparent, with printed labels being easily readable through each.

The sample and control were mounted onto a gold-coated plate at a 45-degree angle over a heater. An IR sensitive camera was focused on the sample and the control, the camera being oriented at right angles with the heater so that only IR reflected by the sample or the control could be detected. A shield was also set up to block the heater from view of the IR camera. The configuration 600 is shown in FIG. 6, where the IR camera 620 is supported by a stand 621 and positioned to image the sample 610 mounted on the reflective plate 611, which is exposed to IR from heater 680 that is shielded from the camera 620 by a heat shield 690.

The IR camera resolved the IR absorbing pattern disposed on the SRF, demonstrating that a patterned IR absorber disposed on an IR reflecting substrate can be resolved by an IR imager. Imaging of the control sample demonstrated uniform response to IR over the entire area of the SRF sample film.

The present invention should not be considered limited to the particular examples described above, but rather should be understood to cover all aspects of the invention as fairly set out in the attached claims. Various modifications and equivalent processes, as well as numerous structures to which the present invention may be applicable will be readily apparent to those of skill in the art to which the present invention is directed upon review of the instant specification.

What is claimed is:

1. A position detection device comprising:
a transparent overlay configured for viewing a display therethrough, the overlay comprising a pattern of transparent material, the pattern being indicative of position; and
a detection device configured to read the pattern when the detection device is suitably positioned.

2. The position detection device of claim 1, wherein the pattern comprises an infrared absorbing material patterned on an infrared reflecting substrate.

3. The position detection device of claim 1, wherein the pattern comprises an infrared absorbing material patterned on an infrared transmissive substrate.

4. The position detection device of claim 1, wherein the pattern comprises an infrared reflecting material patterned on an infrared absorbing substrate.

5. The position detection device of claim 1, wherein the pattern comprises an infrared reflecting material patterned on an infrared transmissive substrate.

6. The position detection device of claim 1, wherein the detection device comprises a stylus housing an infrared sensitive imager configured to detect infrared radiation through an aperture in the stylus tip.

7. The position detection device of claim 6, wherein the stylus further includes an infrared emitter adapted to expose a portion of the overlay to infrared radiation for detection of the pattern.

8. The position detection device of claim 6, wherein the stylus is configured such that the pattern may be detected and resolved when the stylus tip is hovering above the surface of the transparent overlay.

9. The position detection device of claim 8, wherein the pattern can be detected and resolved throughout a range that includes contact of the stylus tip on a touch surface of the overlay surface to about 15 mm above the touch surface.

10. The position detection device of claim 6, wherein the stylus housing incorporates a physical contact detection mechanism to detect when the stylus housing is in contact with a touch surface of the transparent overlay.

11. The position detection device of claim 1, wherein the detection device comprises electronics for determining the position information.

12. The position detection device of claim 1, wherein the detection device further includes an infrared radiation emitter configured for directing infrared radiation toward the overlay when the detection device is suitably positioned to resolve the pattern.

13. The position detection device of claim 1, wherein the detection device further comprises an infrared radiation detector capable of detecting infrared radiation reflected from or transmitted through the transparent overlay, the detector configured to resolve the pattern when the detection device is suitably positioned adjacent to the overlay to thereby determine position information.

14. The position detection device of claim 1, further comprising electronics configured to determine position information from information gathered when the detection device reads the pattern.

15. The position detection device of claim 14, wherein the position information includes X-Y coordinates.

16. The position detection device of claim 14, wherein the position information includes detection device orientation.

17. The position detection device of claim 14, wherein the electronics are housed within the detection device.

18. The position detection device of claim 14, wherein the electronics are housed within a host system in communication with the detection device.

19. A method for making a position detection device comprising:
providing a transparent substrate; and
patterning a transparent material in a coded pattern indicative of position on the substrate so that the coded pattern can be read by a detection device to determine position of the detection device when the detection device is suitably positioned adjacent to the substrate.

20. The method of claim 19, further comprising disposing the substrate over a display so that the display is viewable therethrough.
